(19) United States
(12) Patent Application Publication
(10) Pub. No.: US 2021/0086361 A1
(43) Pub. Date: Mar. 25, 2021

(54) ANOMALY DETECTION FOR ROBOTIC ARMS USING VIBRATION DATA

(71) Applicant: Hitachi, Ltd., Tokyo (JP)

(72) Inventors: Wei HUANG, San Jose, CA (US); Hideaki SUZUKI, Santa Clara, CA (US); Ahmed Khairy FARAHAT, Santa Clara, CA (US); Chetan GUPTA, San Mateo, CA (US)

(73) Assignee: Hitachi, Ltd.

(21) Appl. No.: 16/576,429

(22) Filed: Sep. 19, 2019

(51) Int. Cl. B25J 9/16; B25J 19/02

(52) U.S. Cl. CPC B25J 9/1674; G05B 19/058; B25J 19/026

(57) ABSTRACT

Example implementations described herein involve an anomaly detection method for robotic apparatuses such as robotic arms using vibration data. Such example implementations can involve fluctuation-based anomaly detection (e.g., based on their fluctuations in the vibration measurements) and/or frequency spectrum-based anomaly detection (e.g., based on their natural fluctuations in the vibration measurements).

### BACKGROUND

### Field

The present disclosure relates to robotic apparatuses, and more specifically, to conducting anomaly detection for robotic arms and other robotic apparatuses uses vibration data.

### Related Art

Industrial robotic arms in manufacturing are preprogramed manipulators configured to accomplish operations by following the designed movement. In smart industries, there are vibration sensors mounted on the robotic arms to monitor their movement during operations. Any mechanical system naturally vibrates and generates vibration signals which can be measured by the mounted vibration sensors. The measured vibration signals are the combination of natural vibrations superposed on the moving trajectories. Robotic arms are typically operating multiple types of jobs/actions (e.g. different tasks, different target) and not all of the vibration measurements capture the failure pattern. This is because different operations have different usage of mechanical components and the vibrations associated with the operations more dependent on the failed components contain more failure information.

The deviation of the real movement from the designed trajectory is one failure pattern that can be captured for anomaly detection. However, there can also be hidden anomalies before the appearance and detection of such deviations. Developing a method for failure prediction based on anomaly detection without considering the variability of the operations may result in a high false alarm rate.

### SUMMARY

Aspects of the present disclosure involve a method, which can include receiving vibration sensor data from sensors associated with a robotic apparatus configured to perform an activity from a plurality of preset activities; clustering the vibration sensor data to determine the activity the robotic apparatus is performing; executing a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window; and providing the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus.

Aspects of the present disclosure can further include a non-transitory computer readable medium, storing instructions for executing a process, the instructions involving receiving vibration sensor data from sensors associated with a robotic apparatus configured to perform an activity from a plurality of preset activities; clustering the vibration sensor data to determine the activity the robotic apparatus is performing; executing a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window; and providing the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus.

Aspects of the present disclosure can further include a system which can involve means for receiving vibration sensor data from sensors associated with a robotic apparatus configured to perform an activity from a plurality of preset activities; means for clustering the vibration sensor data to determine the activity the robotic apparatus is performing; means for executing a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window; and means for providing the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus.

### BRIEF DESCRIPTION OF DRAWINGS

FIG. 1 illustrates an anomaly detection approach, in accordance with an example implementation.

FIG. 2 illustrates fluctuation-based anomaly detection, in accordance with an example implementation.

FIG. 3 illustrates the learning phase in the fluctuation-based anomaly detection, in accordance with an example implementation.

FIG. 4(a) illustrates a job categorizer in the fluctuation-based anomaly detection, in accordance with an example implementation.

FIG. 4(b) illustrates an example flow diagram of the job categorizer in the fluctuation-based anomaly detection, in accordance with an example implementation.

FIG. 5(a) illustrates an anomaly score calculator, in accordance with an example implementation.

FIG. 5(b) illustrates a flow diagram for the anomaly score calculator, in accordance with an example implementation.

FIG. 6(a) illustrates a batch anomaly score calculator, in accordance with an example implementation.

FIG. 6(b) illustrates an example flow diagram for the batch anomaly score calculator, in accordance with an example implementation.

FIG. 7 illustrates an example of the application phase, in accordance with an example implementation.

FIG. 8 illustrates a job categorizer of the application phase, in accordance with an example implementation.

FIG. 9 illustrates an example of anomaly score calculator in the application phase, in accordance with an example implementation.

FIG. 10 illustrates an example of the batch anomaly score calculator in the application phase, in accordance with an example implementation.

FIG. 11 illustrates the system for the frequency spectrum-based anomaly detection, in accordance with an example implementation.

FIG. 12 illustrates a learning model in accordance with an example implementation.

FIG. 13 illustrates details for the spectrum analysis, in accordance with an example implementation.

FIG. 14(a) illustrates an example of incremental clustering for the learning model, in accordance with an example implementation.

FIG. 14(b) illustrates an example flow for the learning model, in accordance with an example implementation.

FIG. 15 illustrates an application phase, in accordance with an example implementation.

FIG. 16(a) illustrates an anomaly score calculator in the application phase, in accordance with an example implementation.

FIG. 16(b) illustrates an example flow diagram for the anomaly score calculator, in accordance with an example implementation.

FIGS. 17(a) and 17(b) illustrate example plots for illustrating example implementations described herein.

FIG. 18 illustrates an example of a visualization interface that can be provided, in accordance with an example implementation.

FIG. 19(a) illustrates an example physical structure of the system, in accordance with an example implementation.

FIGS. 19(b) to 19(d) illustrate example alert generator systems for the physical structure of the system, in accordance with an example implementation.

FIG. 20 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

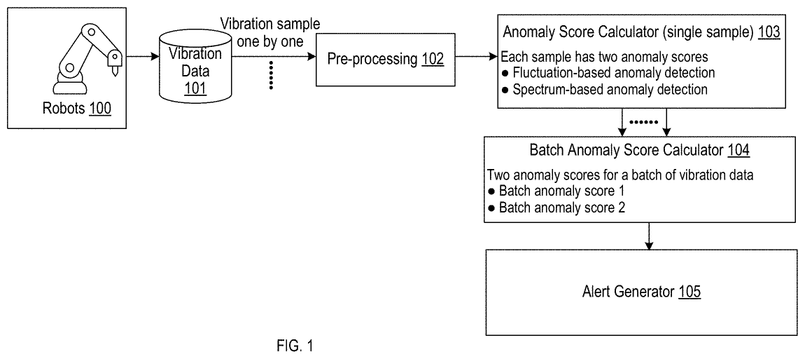

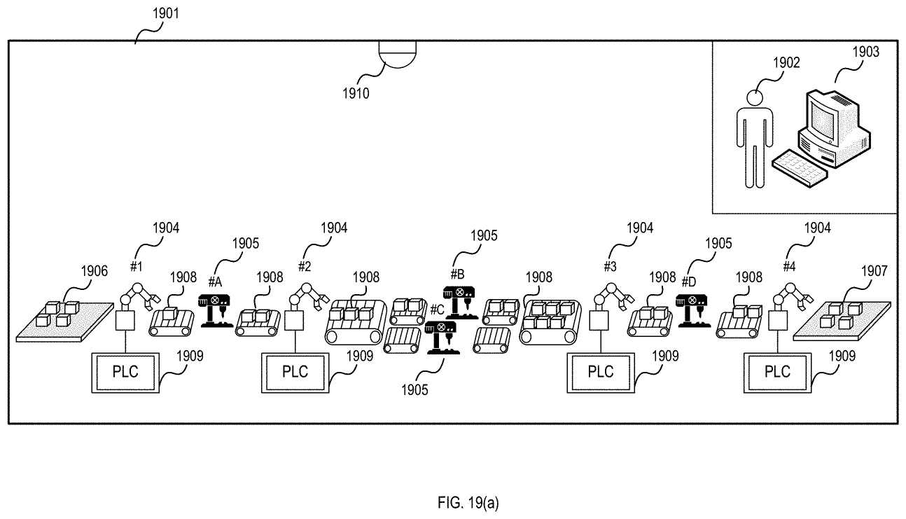

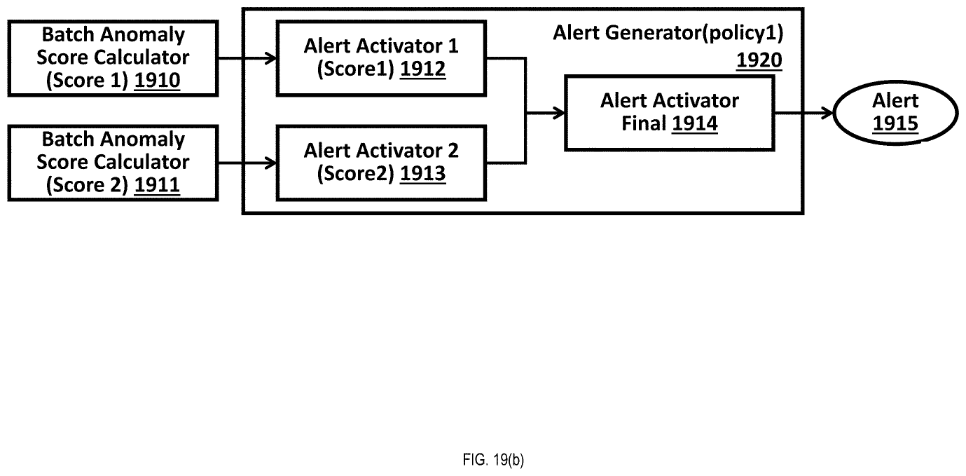

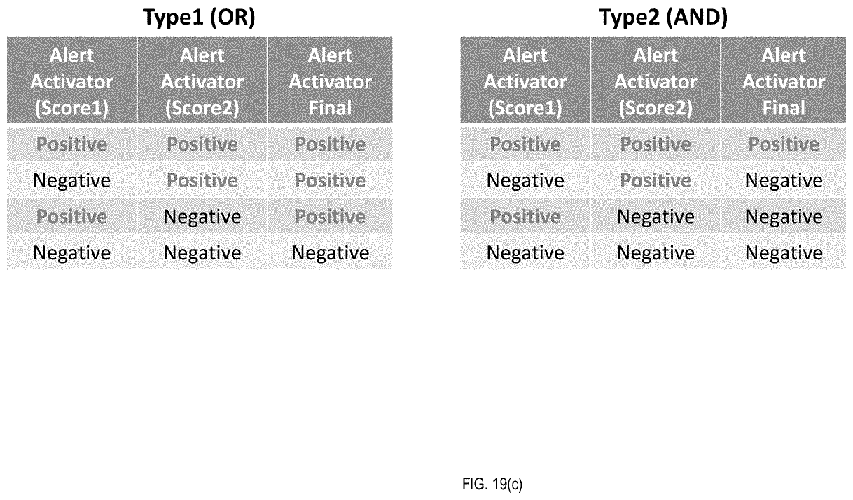

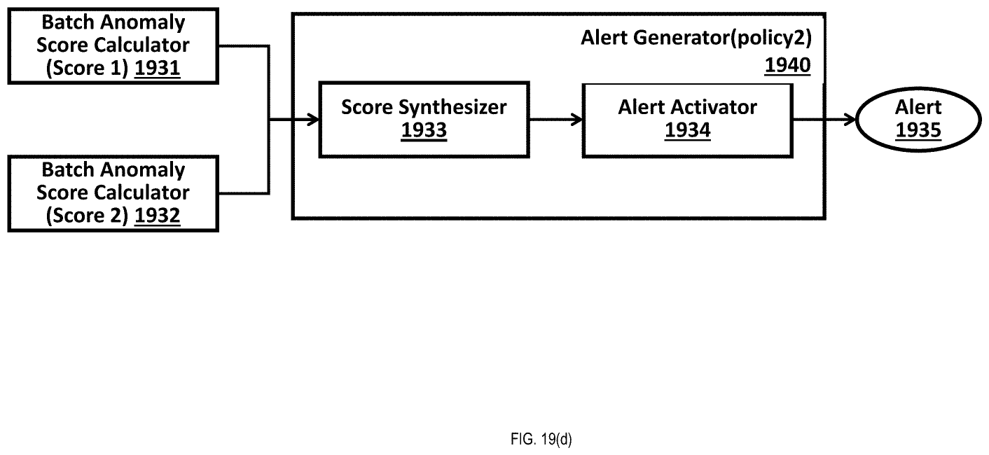

FIG. 1 illustrates an anomaly detection approach, in accordance with an example implementation. As illustrated in FIG. 1, the anomaly detection approach involves a system of robots 100 that provide vibration data 101, samples of which are processed through pre-processing 102 whereupon an single sample anomaly calculator 103 and a batch anomaly score calculator 104 are utilized. Depending on the desired implementation, as will be illustrated in the factory system of FIGS. 19(a) to 19(d), the example anomaly detection system can be integrated into an alert and control system through an alert generator 105.

In example implementations described herein, there is an anomaly detection approach for robotic arm systems based on vibration measurements. The anomaly detection approach incorporates two methods to capture different anomalies in vibration, namely a fluctuation-based anomaly detection, and a spectrum-based anomaly detection.

In the fluctuation-based anomaly detection, short time pulse noises (strong peaks) in the vibration are captured. Such short time pulses have a relatively broader frequency band, which can be difficult to notice in the frequency spectrum in a spectrum analysis pre-defined window.

The spectrum-based anomaly detection uses frequency spectrums in a pre-defined window using spectrum analysis and monitoring the deviation from normal frequency spectrums. The frequency spectrums involve moderately longer time (pre-defined window) patterns.

The vibration data 101 involves vibration signals measured from mounted vibration sensors on the robots 100. The vibration sensor can be multi-dimensional to measure the movement in multiple dimensions. The vibration measurements are segmented into files where each file corresponding to one operation. The vibration measurements are the combination of natural fluctuations from the robotic arm mechanical system superposed on the moving trajectories.

$$\begin{matrix}Vibration \\ signal\end{matrix} = \begin{matrix}Movement \\ trajectory\end{matrix} + \begin{matrix}Superposed \\ natural \\ fluctuations\end{matrix}$$

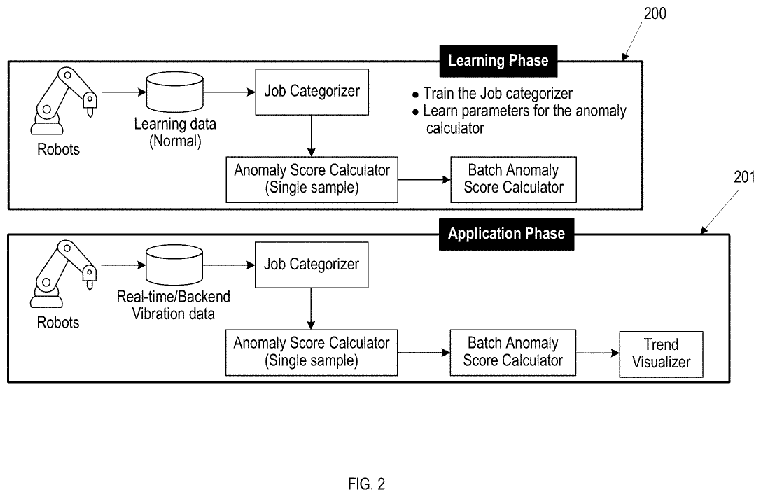

FIG. 2 illustrates fluctuation-based anomaly detection, in accordance with an example implementation. In example implementations described herein, there is a learning phase 200 to train the job categorizer, anomaly score calculator, and batch anomaly score calculator according to fluctuation-based anomaly detection. In the application phase 201, the job categorizer, anomaly score calculator, and batch anomaly score calculator are then deployed to receive real time or backend vibration data.

In fluctuation-based anomaly detection, example implementations involve an anomaly detection method for the robotic arms based on their fluctuations in the vibration measurements. The anomaly indicator is defined to characterize the noisy level of the fluctuations by using a thresholding mechanism. For different types of operations, the normal ranges of the fluctuation are learned respectively using normal vibration measurements. A thresholding mechanism is then applied to count the number of peaks in a vibration measurement (associated to one operation) that beyond the pre-learned normal range. The anomaly indicator is the peak density which is the number of peaks normalized by the time duration of the vibration measurement. There are two phases involved in the fluctuation-based anomaly detection: the learning phase and the application phase.

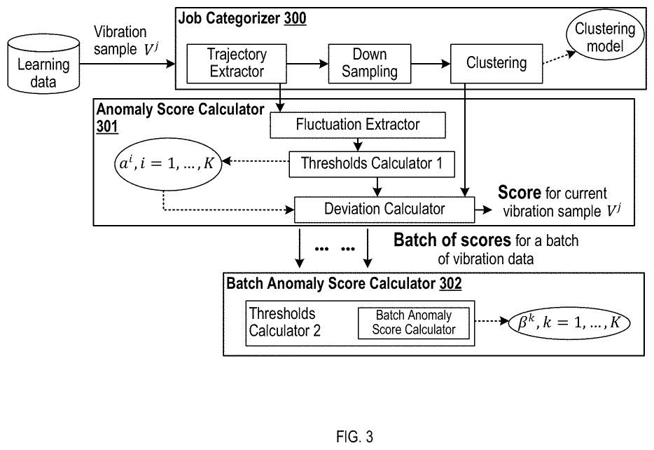

FIG. 3 illustrates the learning phase in the fluctuation-based anomaly detection, in accordance with an example implementation. In the learning phase 200, the job categorizer 300 is trained to identify different robot operation types. Parameters in the Anomaly Score Calculator (single sample) 301 and the Batch Anomaly Score Calculator 302 are learned for each job type respectively. The Anomaly Score Calculator 301 and the Batch Anomaly Score Calculator 302 are based on the thresholding mechanism.

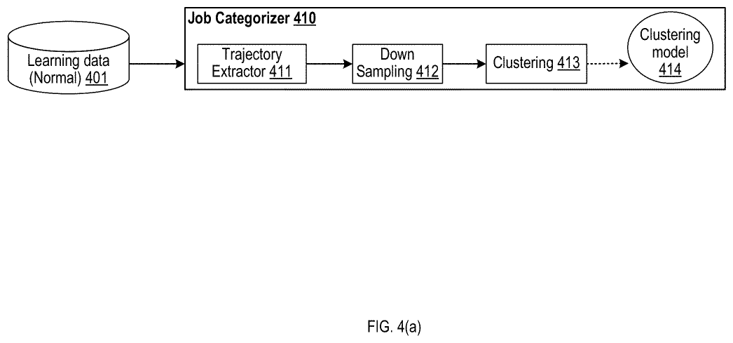

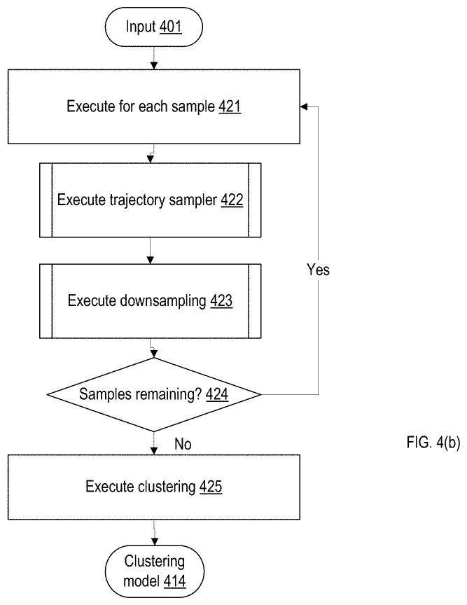

FIG. 4(a) illustrates a job categorizer in the fluctuation-based anomaly detection, in accordance with an example implementation. Given learning data 401, the job categorizer 410 is trained to sort the vibrations into different groups which are possibly associated with different jobs or operations. Different operations have different designed movement trajectories. The job categorizer 410 first applies a moving average smoothing to the vibration data to extract the general movement trajectories, which are then used for categorizing.

Trajectory extractor 411: A sliding averaging window is used to smooth over the fluctuation in the original vibration and extract the general movement trajectory as movement signature. The extracted movement signature for each multi-dimensional original vibration signal has the same dimension and length.

Downsampling 412: In this step, each extracted multi-dimensional smooth movement trajectory is first down-sampled to a fixed length n (e.g. n=50) in each dimension, and then concatenated to form a 1-dimension vector with element number equals to n times the dimension.

Clustering 413: In this step, the 1-dimension vectors from vectorization stage are the input to any unsupervised clustering algorithm (k-means is the preferred embodiment) to perform a grouping task which is used in clustering model 414.

FIG. 4(b) illustrates an example flow diagram of the job categorizer in the fluctuation-based anomaly detection, in accordance with an example implementation. The vibration data 401 is used as input. In particular, the input involves vibration data for learning V=[V¹, . . . ,Vⁱ, . . . ,V^{N}], where N is the total number of samples, Pre-defined smoothing window size: w, and pre-defined length for vibration down-sampling: L.

At 421, a process for the trajectory extractor 411 and downsampling 412 is executed iteratively for each vibration sample Vⁱ=[v₁ⁱ, . . . , vⱼⁱ, . . . vₙ_{ᵢ}ⁱ] in V, where nᵢ is the number of measurements in Vⁱ.

At 422, the trajectory extractor 411 is executed by using a moving average to extract the smoothed vibration Vₛₘₒₒₜₕⁱ with smoothing window size: w

$${V}_{smooth}^{i} = Moving Average ( {V}^{i} ) = [ {v}_{{smooth}_{1}}^{i} , … , {v}_{{smooth}_{j}}^{i} , … , {v}_{{smooth}_{{n}_{i}}}^{i} ] , where {v}_{{smooth}_{j}}^{i} = \frac{1}{w} {\sum }_{r = j - \frac{w}{2}}^{j + \frac{w}{2}} {v}_{r}^{i}$$

At 423, the downsampling 412 is executed, involving shortening the Vₛₘₒₒₜₕⁱ to create Vₜᵣₐⱼⁱ of length: L by using down-sampling:

Vₜᵣₐⱼⁱ=Downsampling(Vₛₘₒₒₜₕⁱ,L)

At 424, a determination is made as to whether each of the vibration samples is processed. If there are samples remaining (Yes) then the flow reiterates at 421 to proceed to the next sample, otherwise (No), the flow proceeds to 425 to execute the clustering 413 to generate the cluster model.

At 425, the clustering 413 is conducted to generate the cluster model based on the smoothing and downsampling conducted for all of the samples through the process of 421-424. In clustering 413,

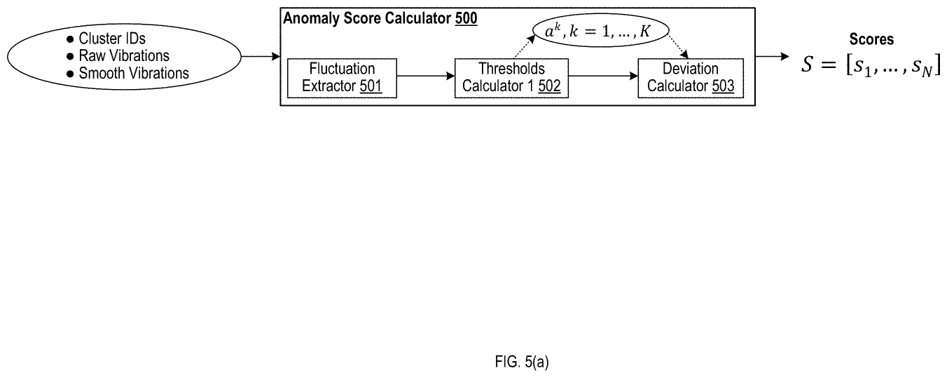

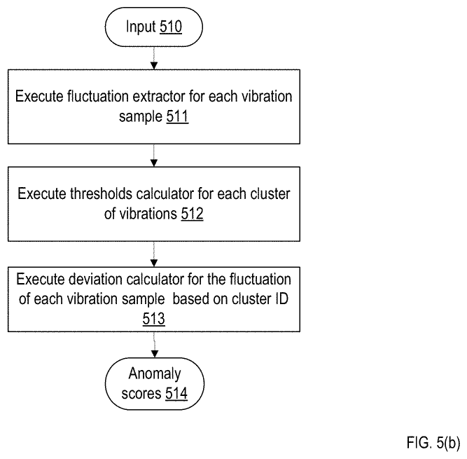

FIG. 5(a) illustrates an anomaly score calculator, in accordance with an example implementation. Anomaly score calculator 500 takes in input such as cluster identifiers (IDs), raw vibrations and smooth vibrations, and provides corresponding anomaly scores. Anomaly score calculator 500 processes such input through a fluctuation extractor 501, a thresholds calculator 502, and a deviation calculator 503. Further details of the flow of anomaly score calculator 500 are provided with respect to FIG. 5(b).

FIG. 5(b) illustrates a flow diagram for the anomaly score calculator, in accordance with an example implementation. At 510, the input of the vibration data set for learning:V =[V¹, . . . ,Vⁱ, . . . ,V^{N}], the smoothed vibrations Vₛₘₒₒₜₕ=[Vₛₘₒₒₜₕ¹, . . . ,Vₛₘₒₒₜₕ¹, . . . ,Vₛₘₒₒₜₕ^{N}], and the Cluster IDs: C=[c¹, . . . ,cⁱ, . . . ,c^{N}], cⁱ∈[1,2, . . . ,k, . . . ,K] are provided to the anomaly score calculator 500.

At 511, the anomaly score calculator 500 executes the fluctuation extractor 501. For each vibration sample Vⁱ=[v₁ⁱ, . . . ,vⱼⁱ, . . . ,vₙ_{ᵢ}ⁱ] in V, where nᵢ is the number of measurements in Vⁱ, the fluctuation extractor 501 obtains the fluctuation component V_{fluct}ⁱ by subtracting Vₛₘₒₒₜₕⁱ from Vⁱ, such that

$${V}_{fluct}^{i} = absolute ( {V}^{i} - {V}_{smooth}^{i} ) = [ absolute ( {v}_{1}^{i} - {v}_{{smooth}_{1}}^{i} ) , … , absolute ( {v}_{{n}_{i}}^{i} - {v}_{{smooth}_{{n}_{i}}}^{i} ) ] = [ {v}_{{fluct}_{1}}^{i} , … , {v}_{{vluct}_{{n}_{i}}^{i}} ]$$

At 512, the anomaly score calculator 500 executes the thresholds calculator 502 for each cluster of vibrations. For each cluster of vibrations V^{c}^{^{k}}=[V₁^{c}^{^{k}}, . . . ,Vₘ^{c}^{^{k}}, . . . ,V_{M}_{ₖ}^{c}^{^{k}}], C^{k}∈[1,2, . . . ,K], where Σₖ₌₁^{K}Mₖ=N, thresholds calculator 1 502 calculates, for each cluster, the range of the fluctuation by using the mean and standard deviation of the fluctuation in each vibration belong to the cluster, such that:

$${a}^{k} = \frac{1}{{M}_{k}} {\sum }_{m = 1}^{{M}_{k}} Mean ( {V}_{{fluct}_{m}}^{{c}^{k}} ) + θ \times \frac{1}{{M}_{k}} {\sum }_{m = 1}^{{M}_{k}} Standard Deviation ( {V}_{{fluct}_{m}}^{{c}^{k}} ) , where θ = 5$$

At 513, the anomaly calculator 500 executes the deviation calculator 503 for the fluctuation of each vibration sample based on cluster ID. That is, for each vibration sample Vⁱ, use the fluctuation: V_{fluct}ⁱ=[v_{fluct}_{₁}ⁱ, . . . ,v_{fluct}_{ₙᵢ}ⁱ], where nᵢ is the number of elements in Vⁱ. Given its cluster id: cⁱ, get its threshold value a^{k} where cⁱ=k, whereupon the deviation calculator 503 calculates anomaly scores, such that anomaly score sⁱ=the percentage of elements in V_{fluct}ⁱ with value above the threshold a^{k}

Sᵢ=percentage(V_{fluct}^{t}>a^{k})

At 514, the corresponding set of anomaly scores S are provided as output.

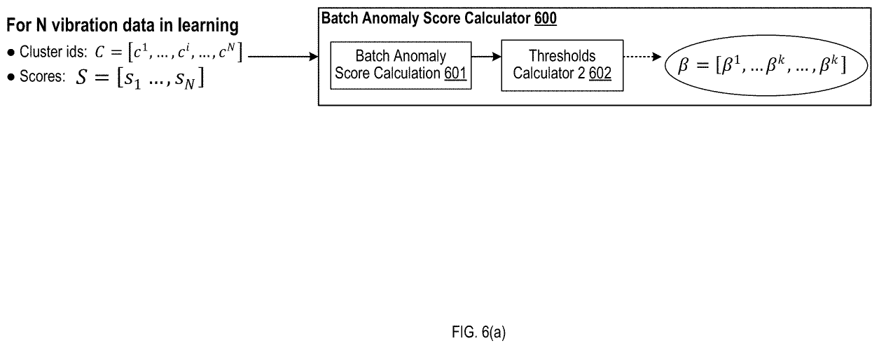

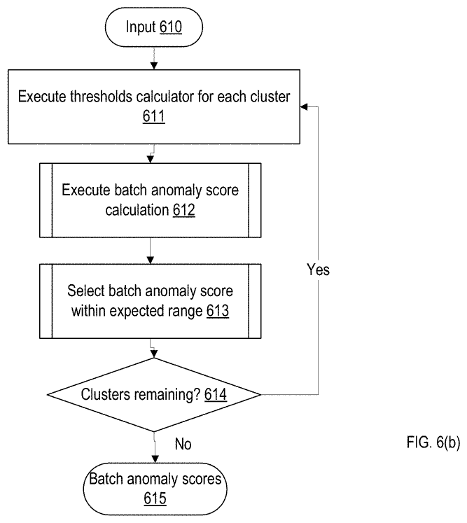

FIG. 6(a) illustrates a batch anomaly score calculator, in accordance with an example implementation. Batch anomaly score calculator 600 involves a batch anomaly score calculation 601 and a thresholds calculator 602. Input to batch anomaly score calculator 600 can involve vibration data set for learning, cluster IDs and anomaly scores, wherein the output is the batch anomaly score. The flow for batch anomaly score calculator 600 is provided in FIG. 6(b).

FIG. 6(b) illustrates an example flow diagram for the batch anomaly score calculator, in accordance with an example implementation. At first, the batch anomaly score calculator 600 takes in input 610 involving Cluster ids: C=[c¹, . . . ,cⁱ, . . . ,c^{N}], cⁱ∈[1, . . . ,k, . . . , K], and Anomaly scores: S=[s₁. . . , s_{N}].

At 611, the batch anomaly score calculator 600 executes thresholds calculator 2 611 for each cluster, and considers all of the learning data as one batch. That is, for each cluster k, thresholds calculator 2 611 get the scores for the vibration samples in the cluster k: S^{k}=[s₁^{k}. . . , sₘₙ_{ₖ}^{k}], where Σₖ₌₁^{K}nₖ=N.

At 612, the batch anomaly score calculation 601 is executed. For β^{k} in a range of values: [minimum(S^{k}), . . . ,maximum(S^{k})], the batch anomaly score calculation 601 calculates the batch anomaly score: p^{k}=BatchAnomaly(S^{k},β^{k})

wherein P=BatchAnomaly(S,β)=Percentage(S≥β)

At 613, the thresholds calculator 2 602 selects the batch anomaly score within an expected range. That is, for each cluster k, thresholds calculator 2 602 selects the β^{k} value which produce Batch Anomaly score: p^{k} closest to a predetermined small value(e.g., 10%) for the learning data (which are normal measurements) . Since learning data is collected in the normal condition, p^{k} should be a small value, and therefore β^{k} should be a large value. In example implementations, a higher β^{k} indicates less sensitivity to failures related to strong fluctuation.

At 614, a determination is made as to whether there are clusters that remain to be processed. If so (Yes), then the flow proceeds to 611 to execute the thresholds calculator 2 602 for the next cluster, otherwise (No) the flow proceeds to 615 to output batch anomaly scores P. The whole range of Batch anomaly score can be normalized to [0,1], where 1 means highest anomaly. In an example implementation, for the learning data which is considered to be the normal condition, the batch anomaly score can be set close to a predetermined small value (e.g. 0.1 which is 10%).

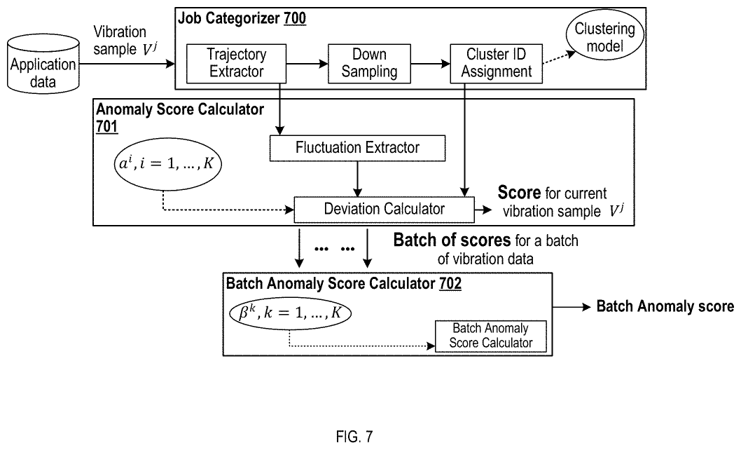

FIG. 7 illustrates an example of the application phase, in accordance with an example implementation. In application phase 201, the samples in application data will be passed to the trained model sequentially. Each sample will have one anomaly score after the job categorizer 700 and anomaly score calculator 701. After the anomaly scores are calculated for a batch of samples in a pre-defined batch window, the batch of anomaly scores will be passed to the batch anomaly score calculator 702 to calculate a batch anomaly score value.

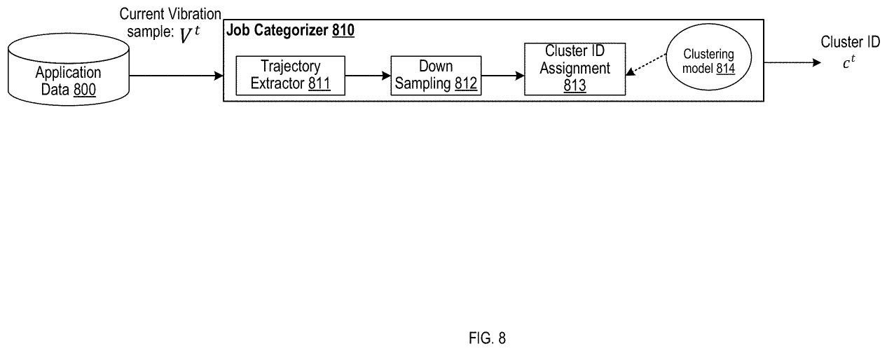

FIG. 8 illustrates a job categorizer of the application phase, in accordance with an example implementation. In the application phase, the vibration sample from the application data 800 will be transformed to the appropriate format through the trajectory extractor 811 and down-sampling 812. Then, the cluster ID assignment 813 will assign the cluster ID to current vibration sample based on the trained clustering model generated from the learning phase. The job categorizer 810 can thereby be configured to determine the appropriate job through execution of the flow as follows.

The input for job categorizer 810 from the application data 800 involves current vibration sample in application V^{t}=[v₁^{t}, . . . ,vᵢ^{t}, . . . ,vₙ^{t}], where n is the number of elements in V^{t}, pre-defined smoothing window size: w, and pre-defined length for vibration down-sampling: L. Trajectory extractor 811 then uses the moving average to extract the smoothed vibration Vₛₘₒₒₜₕ^{t} with smoothing window size: w, such that

$${V}_{smooth}^{t} = Moving Average ( {V}^{t} ) = [ {v}_{{smooth}_{1}}^{t} , … , {v}_{{smooth}_{i}}^{t} , … , {v}_{{smooth}_{n}}^{t} ] , where {v}_{{smooth}_{i}}^{t} = \frac{1}{w} {\sum }_{r = i - \frac{w}{2}}^{i + \frac{w}{2}} {v}_{r}^{t}$$

Downsampling 812 then shortens the Vₛₘₒₒₜₕ^{t} to create Vₜᵣₐⱼ^{t} with the length of L by using down-sampling as follows:

Vₜᵣₐⱼ^{c}=Downsampling(Vₛₘₒₒₜₕ^{L},L)

Wherein the output: Vₜᵣₐⱼ^{t}=[vₜᵣₐⱼ_{ᵢ}^{t}, . . . ,vₜᵣₐⱼ_{ᵢ}^{t}, . . . vₜᵣₐⱼ_{_{L}}^{t}], has L elements

Cluster ID assignment 813 then utilizes the clustering model 814 trained in the learning phase to assign the cluster id: id^{c} for current vibration V^{c} based on Vₜᵣₐⱼ^{t}=[vₜᵣₐⱼ^{t}, . . . ,vₜᵣₐⱼ_{ᵢ}^{t}, . . . ,vₜᵣₐⱼ_{_{L}}^{t}]

The resulting output is cluster IDs c^{t}=Clustering Model(clusters=K), predict(Vₜᵣₐⱼ^{c}), c^{t}∈[1, . . . ,K]

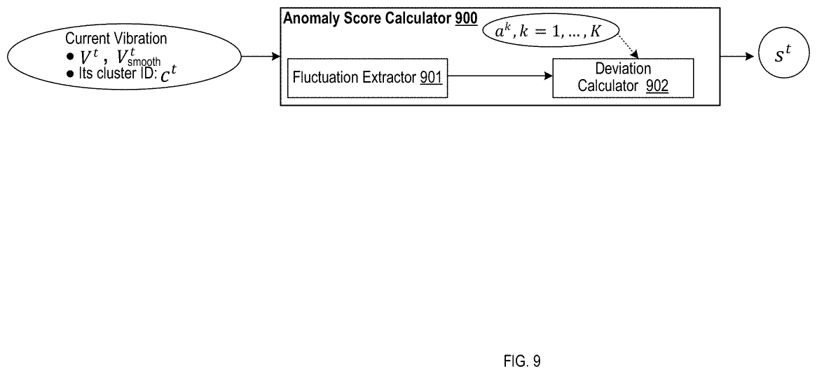

As described herein, Clustering Model can involve any type of unsupervised clustering model in accordance with the desired implementation, such as K-means. FIG. 9 illustrates an example of anomaly score calculator in the application phase, in accordance with an example implementation. The anomaly score calculator 900 will calculate an anomaly score for current vibration sample. As illustrated in FIG. 9, the types of input into anomaly score calculator 900 can include the current vibration sample: V^{t}=[v₁^{t}, . . . ,vᵢ^{t}, . . . ,vₙ^{t}], the smoothed version: Vₛₘₒₒₜₕ^{t}=[ₛₘₒₜₕ_{₁}^{t}, . . . vₛₘₒₒₜₕ_{ᵢ}^{t}, . . . , vₛₘₒₒₜₕ_{ₙ}^{t}], and the cluster id: c^{t}, where c^{t}∈[1, . . . ,K].

Fluctuation extractor 901 takes the input and obtains the fluctuation component V_{fluct}¹ by subtracting Vₛₘₒₒₜₕ^{t} from V^{t} such that:

V_{fluct}^{t}=absolute(V^{t}−Vₛₘₒₒₜₕ^{t})=[absolute(v₁^{t}−vₛₘₒₒₜₕ_{₁}^{t}), . . . ,absolute(vₙ^{t}vₛₘₒₒₜₕ_{ₙ}^{t})]=[v_{fluct}_{₁}^{t}, . . . ,v_{fluct}_{ᵢ}^{t}, . . . ,v_{fluct}_{ₙ}^{t})]

Deviation calculator 902 can obtain the threshold value a^{c}^{^{t}}, c^{t}∈[1, . . . ,k], based on the cluster id: c^{t} and the thresholds a^{k}, k=1, . . . ,K, learned in the learning phase, and then calculate the anomaly score=the percentage of elements in V_{fluct}^{t} with the value above the threshold a^{c}^{^{t}}. The output of the anomaly score calculator 900 is s^{t}=Percentage(V_{fluct}^{t}>a^{c}^{^{t}})

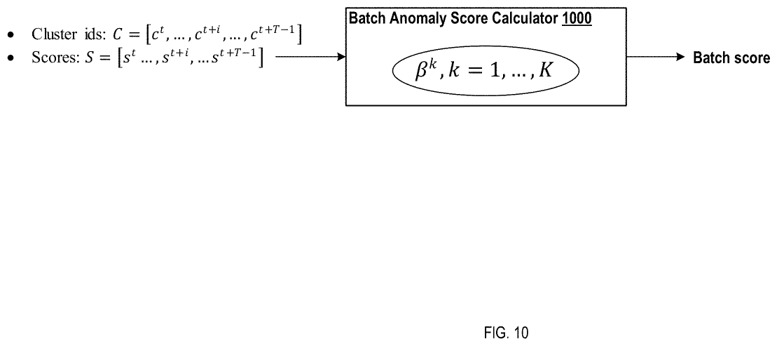

Then, the anomaly scores are calculated for a batch of vibration samples V=[V^{t}, . . . ,V^{t+i}, . . . ,V^{t+T-1}], where T is the batch size (e.g., number of samples in a time window) as illustrated in FIG. 10.

FIG. 10 illustrates an example of the batch anomaly score calculator in the application phase, in accordance with an example implementation. Batch anomaly score calculator 1000 takes in an input for the current batch of vibration signals that includes Cluster IDs: id=[id^{t}, . . . id^{t+i}, . . . id^{t+T-1}],id^{t+i}∈[1, . . . ,k, . . . ,K], and Anomaly scores: S=[s^{t} . . . ,s^{t+i}, . . . ,s^{t+T}−1].

At first, batch anomaly score calculator 1000 splits the anomaly scores S into clusters: S=[S¹, . . . ,S^{k}, . . . ,S^{K}], where S^{k}=[s₁^{k}, . . . ,sₙ_{ₖ}^{k}], and Σₖ₌₁^{K}nₖ=T

Then, for each cluster of vibration samples in the batch, the batch anomaly score calculator 1000 calculates the batch anomaly score as follows:

p^{k}=BatchAnomaly(S,β)

BatchAnomaly(S,β)=Percentage(S≥β)

Finally, batch anomaly score calculator 1000 sums the batch anomaly score for different clusters to produce one batch anomaly score P:

$$P = \frac{{\sum }_{k = 1}^{K} {n}^{k} \times {p}^{k}}{T}$$

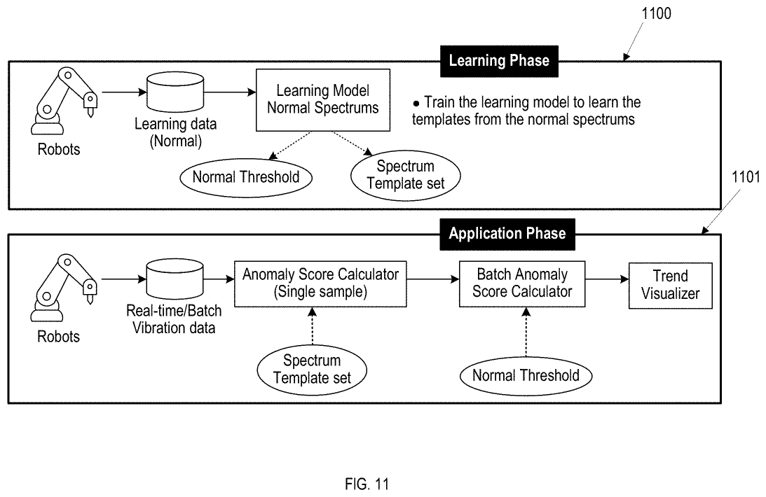

FIG. 11 illustrates the system for the frequency spectrum-based anomaly detection, in accordance with an example implementation. The system for the frequency spectrum-based anomaly detection involves a learning phase 1100 and an application phase 1101. The frequency spectrum-based anomaly detection is based on their natural fluctuations in the vibration measurements. The anomaly indicator is defined to characterize the noisy level of the natural fluctuations by comparing frequency spectrum. For different types of operations, the normal range of the fluctuation is learned respectively as combinations of normal vibration spectrum. The anomaly indicator is defined as the deviation from the most likelihood spectrum which has the minimum distance of all the normal spectrums.

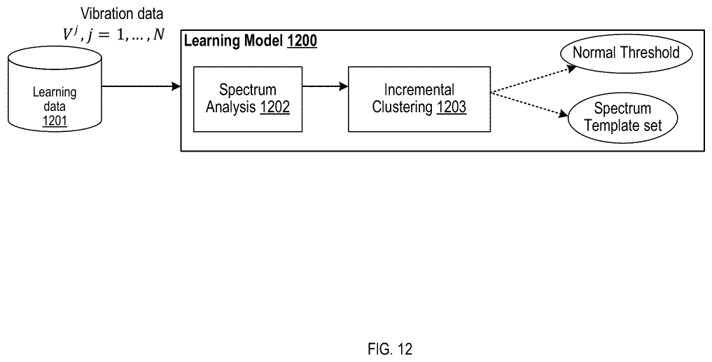

FIG. 12 illustrates a learning model in accordance with an example implementation. Learning model 1200 intakes learning data 1201 as input, which is processed through spectrum analysis 1202 and incremental clustering 1203 to provide a normal threshold and a spectrum template set. Spectrum analysis 1202 can be in the form of short time Fourier transform (STFT) or other types of spectrum analysis depending on the desired implementation.

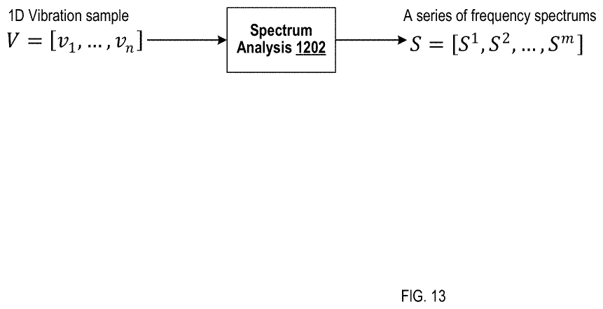

FIG. 13 illustrates details for the spectrum analysis, in accordance with an example implementation. To obtain the motion pattern, example implementations use a motion pattern extractor which calculates the frequency spectrum by using spectrum analysis 1202 for vibration data.

In the following example, STFT is utilized, however, any type of spectrum analysis can be utilized in accordance with the desired implementation. As illustrated in FIG. 13, the input can involve V: vibration data, L_{w}: Window size, and Lₛ: Window shifting length to produce a series of frequency spectrums S=ST FT(V,L_{w},Lₛ).

At first, the spectrum analysis 1202 splits 1D vibration data V=[v₁,v₂, . . . ,vₙ] into a series of windows: U=[U¹,U², . . . ,U^{m}] with overlap where

$${U}^{i} = [ {v}_{( i - 1 ) \times {L}_{s}} , {v}_{( i - 1 ) \times {L}_{s} + 1} , … , {v}_{( i - 1 ) \times {L}_{s} + {L}_{w} - 1} ] , i = 1 , … , m , m = floor ( \frac{n - {L}_{w}}{{L}_{s}} )$$

Then, the spectrum analysis 1202 calculates spectrum S from U by applying FFT (Fast Fourier Transform) to each window of signal Uᵢ,i=1, . . . ,m

S=[S¹,S², . . . ,S^{m}]

The series of frequency spectrums is therefore

$${S}^{i} = FFT ( {U}^{i} ) = [ {s}_{1}^{i} , {s}_{2}^{i} , … , {s}_{\frac{{L}_{w}}{2}}^{i} ] , i = 1 , … , m$$

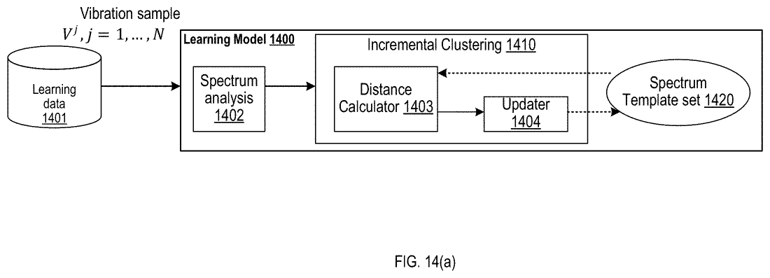

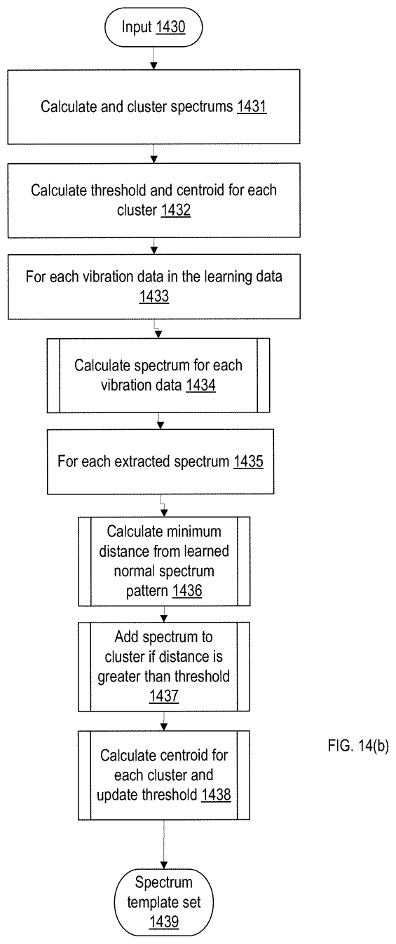

FIG. 14(a) illustrates an example of incremental clustering for the learning model, in accordance with an example implementation. In the example of FIG. 14(a), the learning model 1400 intakes learning data 1401 for processing into a spectrum analysis 1402 and incremental clustering 1410, which utilizes the spectrum template set 1420 in a distance calculator 1403 to provide updates to the spectrum template set 1420 through the updater 1404. An anomaly indicator is defined as a reconstruction deviation which depends on an unsupervised machine learning algorithm. For instance, in case of K-means as follows: An anomaly indicator of an obtained motion pattern xᵢ is defined as a distance from the nearest motion pattern mⱼ. All of anomaly measurement in one file is defined as the summation of each distance.

$$Anomaly indicator = {argmin}_{{m}_{1} , {m}_{2} , … , {m}_{c}} {\sum }_{i = 1}^{n} {min}_{j} ‖ {x}_{i} - {m}_{j} ‖$$

FIG. 14(b) illustrates an example flow for the learning model, in accordance with an example implementation. The series of obtained motion patterns are categorized into given size of groups by using unsupervised machine learning algorithm such as K-means. Input 1430 involves the learning data [V¹, . . . ,V^{N}]. In the following example, spectrum analysis 1402 utilizes STFT, however, other types of spectrum analysis can be utilized in accordance with the desired implementation.

At 1431, the spectrum analysis 1402 calculates the spectrums from the first vibration data V¹ using STFT: S¹=STFT(V¹,L_{w},Lₛ)=[S₁¹, . . . ,Sₙ_{₁}¹]. Then, given a cluster size c, incremental clustering 1410 clusters the spectrums [S₁¹, . . . ,Sₙ_{₁}¹] into c clusters: T¹=[t₁¹, . . . ,tₘ_{₁}¹], T²=[t₁², . . . ,tₘ_{₂}²], . . . ,T^{c}=[t₁^{c}, . . . ,tₘ_{_{c}}^{c}], where n₁=m₁+m₂+ . . . +m_{c} by using a clustering algorithm such as K-means.

At 1432, for each cluster j, distance calculator 1403 calculates centroid

$${M}_{j} = mean ( {T}^{j} ) = \frac{1}{{m}_{j}} {\sum }_{p = 1}^{{m}_{j}} {t}_{p}^{j}$$

and threshold D=maxⱼ(maxₚ(∥tₚ^{j}−Mⱼ∥)) of spectrums belonging to each cluster, wherein M=[M₁,M₂, . . . ,M_{c}] is the learned normal spectrum pattern.

At 1433-1438, each vibration data in the learning data is processed in a loop. That is, for k=[2,3, . . . ,N] from the process of 1433, incremental clustering 1410 repeats the following for each remaining vibration data V^{k} in the learning data.

At 1434, the incremental clustering 1410 calculates the spectrums S^{k} for each vibration data V^{k} such that S^{k}=STFT(V^{k} ,L_{w},Lₛ)=[S₁^{k}, . . . ,Sₙ_{ₖ}^{k}], k=2, . . . ,N

At 1435-1438, each extracted spectrum is processed for the given vibration data in a loop. That is, for each spectrum of spectrums set [S₁^{k},S₂^{k}, . . . ,Sₙ_{ₖ}^{k}] extracted from one vibration data V^{k}, the process 1435 initiates a loop as follows.

At 1436, for each spectrum S₁^{k}, distance calculator 1403 calculates minimum distance dᵢ^{k} from learned normal spectrum pattern dᵢ^{k}=min(∥Sᵢ^{k}−Mⱼ∥), l=argminⱼ(∥Sᵢ^{k}−Mⱼ∥), i=1, . . . ,nₖ,j=1, . . . ,c

At 1437, if dᵢ^{k}>D, incremental clustering 1410 add Sᵢ^{k} to S_{old}¹ as follows

S_{new}¹=S_{old}¹+[Sᵢ^{k}],n₁^{new}=n₁^{old}+1

and then, clusters the spectrum S_{new}¹ into clusters: T_{new}¹,T_{new}², . . . ,T_{new}^{c}

At 1438, for each cluster j, updater 1403 calculates centroid Mⱼ^{new} and update threshold D^{new}

Once all vibration data and spectrums are processed, the result at 1439 is the spectrum template set 1420.

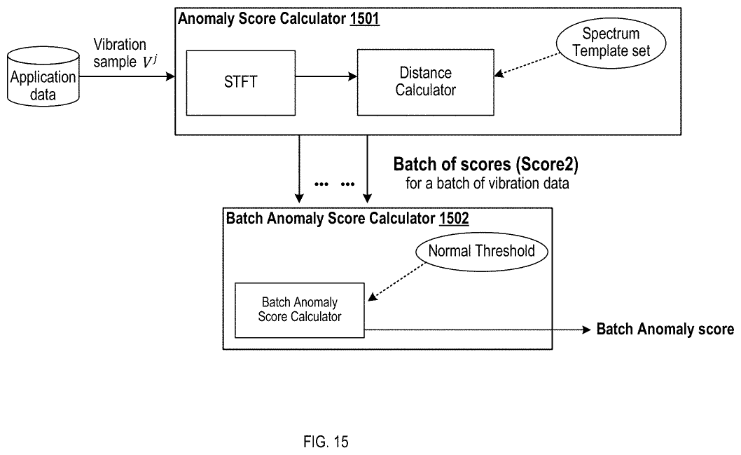

FIG. 15 illustrates an application phase 1101, in accordance with an example implementation. The application phase 1101 involves an anomaly calculator 1501 and a batch anomaly calculator 1502 which operates similarly to the systems illustrated in FIGS. 3 and 7. In the application phase, each sample will have one anomaly score. After the anomaly scores are calculated for a batch of samples in a pre-defined batch window, the batch of anomaly scores will be passed to the batch anomaly score calculator 1502 to calculate a batch anomaly score value.

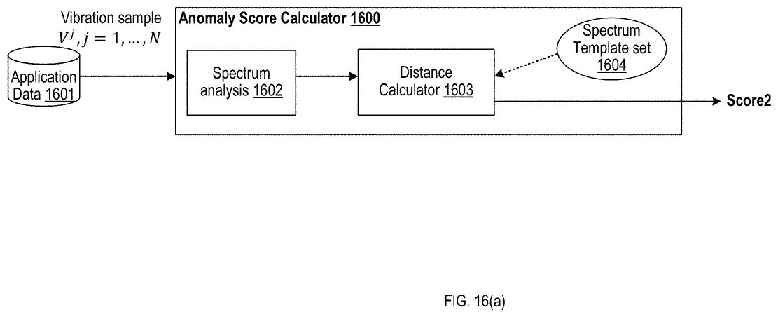

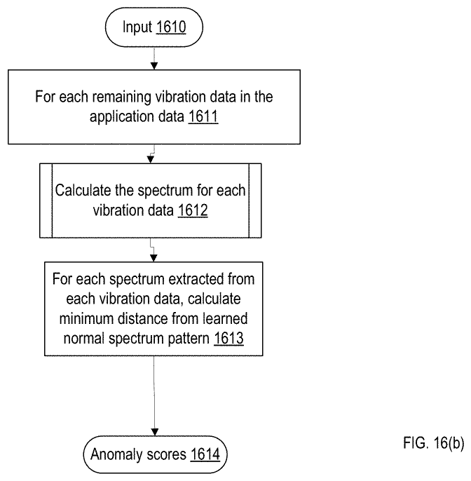

FIG. 16(a) illustrates an anomaly score calculator in the application phase, in accordance with an example implementation. Anomaly score calculator 1600 intakes application data 1601, and involves a spectrum analysis 1602, a distance calculator 1603, and a spectrum template set 1604. Further details for the flow of the anomaly score calculator 1600 are provided in FIG. 16(b).

FIG. 16(b) illustrates an example flow diagram for the anomaly score calculator, in accordance with an example implementation. At 1610, application data [V¹, . . . ,V^{N}] is input and the anomaly score calculator 1600 processes the input based on the learned normal spectrum pattern 1604 M=[M₁,M₂, . . . ,M_{c}]. In the following example, spectrum analysis 1602 utilizes STFT, however, other types of spectrum analysis can be utilized in accordance with the desired implementation.

At 1611, a process loop is initiated for k=[1,2, . . . ,N]. That is, the anomaly score calculator 1600 repeats 1612-1613 for each remaining vibration data V^{k} in the application data.

At 1612, the spectrum analysis 1602 calculates the spectrum S^{k} for each vibration data V^{k}, such that S^{k}=STFT(V^{k},L_{w},Lₛ)=[S₁^{k}, . . . ,Sₙ_{ₖ}^{k}], k=2, . . . ,N

At 1613, for each spectrum of spectrums set [S₁^{k},S₂^{k}, . . . ,Sₙ_{ₖ}^{k}] extracted from one vibration data V^{k}, the distance calculator 1603 calculates the minimum distance dᵢ^{k} from learned normal spectrum pattern dᵢ^{k}=min(∥Sᵢ^{k}−Mⱼ∥), l=argminⱼ(∥Sᵢ^{k}−Mⱼ∥), i=1, . . . ,nₖ,j=1, . . . ,c

At 1614, the anomaly score Score2 of V^{k} is calculated, such that

$$Score 2 ( {V}^{k} ) = \frac{1}{{n}_{k}} {Σ}_{1}^{{n}_{k}} {d}_{i}^{k}$$

An anomaly indicator distribution is a histogram or the density of all the mean anomaly indicator created from all the files in fixed period (for example, one day). A mean of anomaly indicator is the average of all the anomaly indicator corresponding to one file.

A distribution shift is defined as a density ratio of two different anomaly indicator distributions.

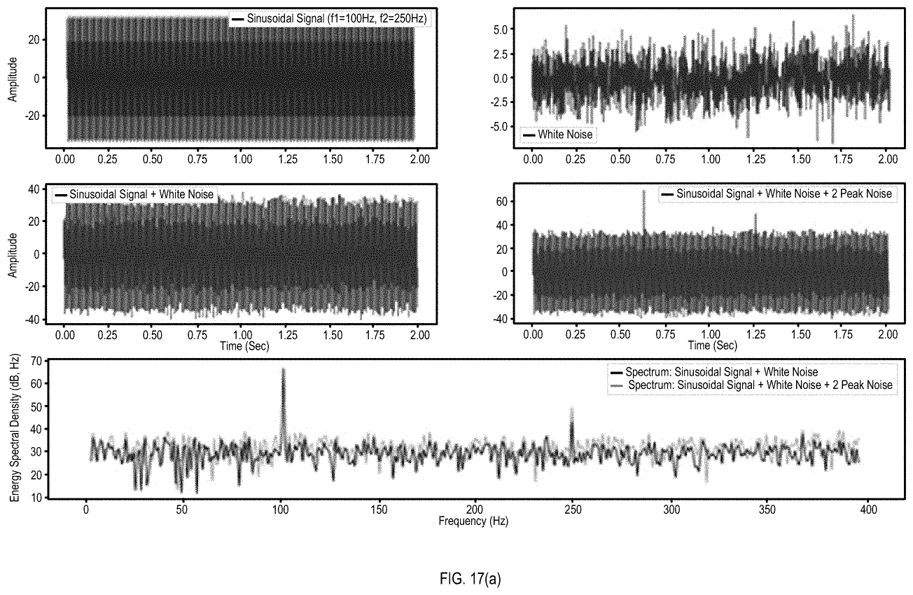

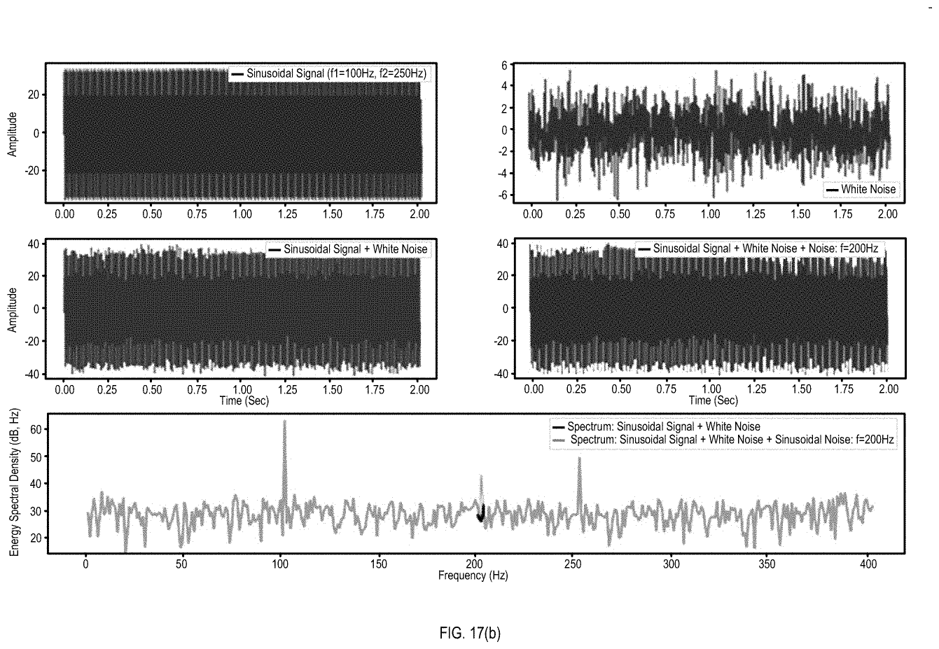

FIGS. 17(a) and 17(b) illustrate example plots for illustrating example implementations described herein. As described herein, the anomaly detection approach incorporates two methods to capture different anomalies in vibration: the fluctuation-based anomaly detection and the spectrum-based anomaly detection. The fluctuation-based anomaly detection aims to capture the short time pulse noises (strong peaks) in the vibration. These short time pulses have relatively broader frequency band, which is hard to be noticed in the frequency spectrum.

FIG. 17(a) illustrates an example simulation of a signal for the fluctuation-based anomaly detection. As shown in FIG. 17(a), the top left plot is the original signal which is a sinusoidal signal with two frequency components at 100 Hz and 250 Hz.

original signal=20×sin 2πf₁t+20×sin 2πf₂t,f₁=100 Hz, f₂250 Hz

A white noise as shown in top right plot is added to the original signal to form a simulated signal as shown in the middle left plot.

simulated signal=original signal+white noise

Then, two pulse noise are added to the simulated signal and form the signal as shown in middle right plot. The frequency spectrum for the simulated signal with and without the pulse noise are plotted in the bottom plot.

From the time domain signal shown in middle right plot, the transient pulse noise can be detected using a thresholding mechanism. However, it can be difficult to observe the deviation by monitoring their frequency spectrums as shown in the bottom plot.

As shown in FIG. 17(b), the top left, top right and middle left plots are the same as in FIG. 17(a), with a sinusoidal noise at 200 Hz is added to the simulated signal to form the signal as shown in middle right plot. The frequency spectrum for the simulated signal with and without the sinusoidal noise is plotted in the bottom plot.

In this case, the sinusoidal noise can be difficult to observer from the time domain signal shown in middle right plot. However, it can be observed by monitoring the deviation of their frequency spectrums as shown in the bottom plot.

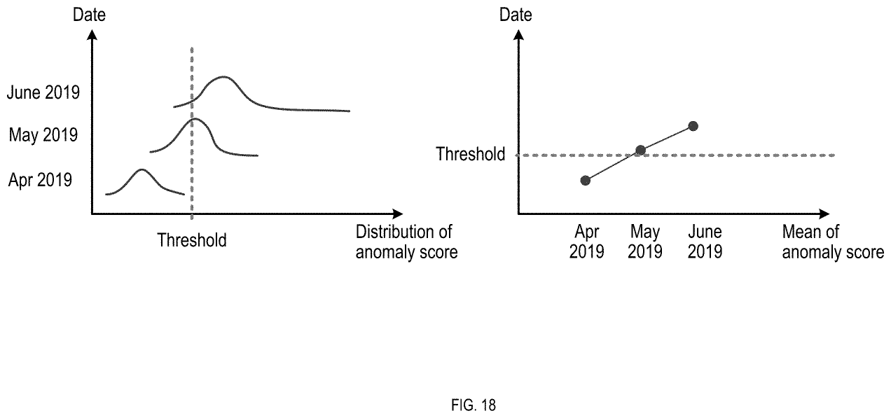

FIG. 18 illustrates an example of a visualization interface that can be provided, in accordance with an example implementation. Specifically, the left plot is the distribution of Score2 and the right plot is Batch Score. Both plots include time trends which explain degradation.

FIG. 19(a) illustrates an example physical structure of the system, in accordance with an example implementation. In a factory 1901, there are lines including one or more moving equipment, such as processing equipment 1905 and robotic arms 1904 that are configured to execute manufacturing processes such as loading components, unloading components, assembling components, and so on. For example, example manufacturing processes can involve processes in which equipment 1905 processes products 1908 and robotic arms 1904 carry products 1908 in accordance with a schedule. Multiple kinds or types of products may be processed at the same time, depending on the desired implementation. Robotic arms 1904 and equipment 1905 can be controlled by Programmable Logic Controllers (PLCs) 1909 to perform one of a plurality of tasks. Workers 1902 dispatch due date and scheduling policies to computing device 1903 which is connected to programmable logic controllers 1909, thereby communicatively coupling the computing device 1903 to the moving equipment via the corresponding PLC and any network in accordance with the desired implementation. In lines, loading products 1906 and unloading products 1907 are managed by production management systems, in accordance with an example implementation. Depending on the desired implementation, a camera system 1910 may also monitor the factory floor 1901.

In example implementations, each of the moving equipment (processing equipment 1905, robotic arms 1904) have one or more vibration sensors attached to them, which provide sensor data to the computing device 1903 via a separate network to the network connected to the PLCs, or with the same network as the PLCs depending on the desired implementation. Such vibration sensor data may be stored in the memory of the computing device 1903 as batch or streaming data, or can be stored in a database configured to be accessible by the computing device 1903. Each of the moving equipment is configured to do an activity from a plurality of preset activities based on a schedule or programming as set by the factory floor. In an example for robotic arms 1904, activities can include loading a product, unloading a product, moving the arm from one location to another location, and so on in accordance with the desired implementation. Such activities can be also be categorized under different types of jobs that is to be handled by the moving equipment (e.g., moving product X, loading/unloading product Y, etc.), so that the moving equipment is configured to handle different types of jobs for the factory.

Computing device 1903 may be configured to generate alerts and control PLCs 1909 based on the alert generated. The alert generation can incorporate the fluctuation-based anomaly detection as well as the spectrum-based anomaly detection to facilitate an alert generation and PLC control policy, in accordance with an example implementation.

FIGS. 19(b) to 19(d) illustrate example alert generator systems for the physical structure of the system, in accordance with an example implementation. Specifically, FIG. 19(b) illustrates an example policy of an alert generator 1920. In such an example implementation, the batch anomaly score calculator 1910 for the fluctuation-based anomaly detection and the batch anomaly score calculator 1911 of the spectrum-based anomaly detection are both taken into consideration. Each type of anomaly detection is associated with a corresponding alert activator 1912 and 1913 to indicate if the batch anomaly score for the underlying anomaly detection method indicates that an alert should be activated or not in accordance with a threshold for the corresponding anomaly detection. An example function for the alert activators 1912 and 1913 can be as follows:

$$AlertActivator ( x ) = {H}_{0} ( x - θ ) = \{ \begin{matrix}1 & x \geq θ \\ 0 & x < θ\end{matrix}$$

θ:threshold o f Activator, x:Score

The alert activators 1912 and 1913 for each of the anomaly detection methods can then be aggregated to a final alert activator 1914 to determine if an alert should be raised. The final alert activator 1914 determines if an alert should be raised based on the results of alert activators 1912 and 1913. The final alert activator 1914 can execute an OR operation determination or an AND operation determination depending on the desired implementation. For example, in a first type (Type1) of an OR operation determination, the determination can be:

AlertActivatorFinal=AlertActivator1(Score1)+AlertActivator2(Score2)

In another example, the AND operation determination can be:

AlertActivatorFinal=AlertActivator1(Score1)×AlertActivator2(Score2)

FIG. 19(c) illustrates an example decision table for the final alert activator 1914 based on each type of operation determination. Once such a determination is made, if an alert is to be issued, then alert 1915 can be raised.

FIG. 19(d) illustrates another example of an alert generator policy 1940, in accordance with an example implementation. In this example implementation, batch anomaly score calculators 1931 and 1932 are similar to those of 1911 and 1912. In this example alert generator policy 1940, there is a score synthesizer 1933 and alert activator 1934. In this example, the score synthesizer 1933 is utilized to assign weights to each of the scores provided by the batch anomaly score calculators 1931 and 1932 to facilitate the desired implementation. In an example implementation, the score synthesizer 1933 can determine a synthesized score as follows:

Synthesized Score=W₁×Score1+W₂×Score2

W₁, W₂:Weight of each score

As such, the weight of each score can be updated based on the confidence of each score, which is determined according to precision of the underlying anomaly detection method for a particular activity. If the synthesized score exceeds a threshold, then alert activator 1934 can thereby be configured to generate an alert 1935.

Depending on the desired implementation, alert 1915 and 1935 can be issued to the corresponding PLC 1909 by computer device 1903 to control the robotic arm 1904 to shut down or enter a safe mode once the alert has been generated. The PLC 1909 may also control the robotic arm 1904 to issue a warning light or make other indications to alert workers on the factory floor that an anomaly has occurred.

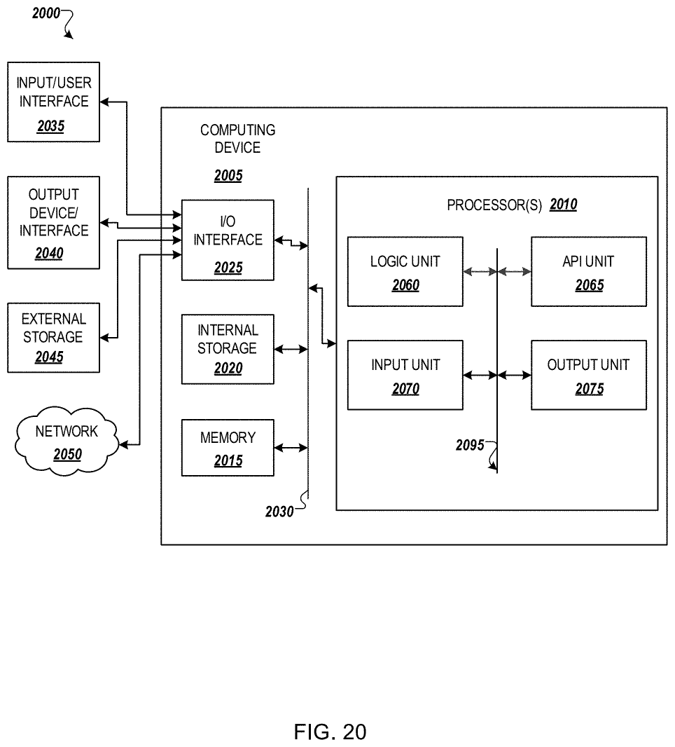

FIG. 20 illustrates an example computing environment with an example computer device suitable for use in some example implementations, such as a computing device 1903 as illustrated in FIG. 19(a). In such an example implementation, the computer device 1903 is connected to one or more programmable logic controllers (PLCs) associated with one or moving equipment on a factory floor over a network as illustrated in FIG. 19.

Computer device 2005 in computing environment 2000 can include one or more processing units, cores, or processors 2010, memory 2015 (e.g., RAM, ROM, and/or the like), internal storage 2020 (e.g., magnetic, optical, solid state storage, and/or organic), and/or I/O interface 2025, any of which can be coupled on a communication mechanism or bus 2030 for communicating information or embedded in the computer device 2005. I/O interface 2025 is also configured to receive images from cameras or provide images to projectors or displays, depending on the desired implementation.

Computer device 2005 can be communicatively coupled to input/user interface 2035 and output device/interface 2040. Either one or both of input/user interface 2035 and output device/interface 2040 can be a wired or wireless interface and can be detachable. Input/user interface 2035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2040 may include a display, television, monitor, printer, speaker, braille, or the like. In some example implementations, input/user interface 2035 and output device/interface 2040 can be embedded with or physically coupled to the computer device 2005. In other example implementations, other computer devices may function as or provide the functions of input/user interface 2035 and output device/interface 2040 for a computer device 2005.

Examples of computer device 2005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2005 can be communicatively coupled (e.g., via I/O interface 2025) to external storage 2045 and network 2050 for communicating with any number of networked components, devices, and systems, including one or more computer devices of the same or different configuration. Computer device 2005 or any connected computer device can be functioning as, providing services of, or referred to as a server, client, thin server, general machine, special-purpose machine, or another label.

I/O interface 2025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2000. Network 2050 can be any network or combination of networks (e.g., the Internet, local area network, wide area network, a telephonic network, a cellular network, satellite network, and the like).

Computer device 2005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 2005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 2010 can execute under any operating system (OS) (not shown), in a native or virtual environment and can be in the form of physical hardware processors such as Central Processing Units (CPUs) or a combination of software and hardware processors. One or more applications can be deployed that include logic unit 2060, application programming interface (API) unit 2065, input unit 2070, output unit 2075, and inter-unit communication mechanism 2095 for the different units to communicate with each other, with the OS, and with other applications (not shown). The described units and elements can be varied in design, function, configuration, or implementation and are not limited to the descriptions provided.

In some example implementations, when information or an execution instruction is received by API unit 2065, it may be communicated to one or more other units (e.g., logic unit 2060, input unit 2070, output unit 2075). In some instances, logic unit 2060 may be configured to control the information flow among the units and direct the services provided by API unit 2065, input unit 2070, output unit 2075, in some example implementations described above. For example, the flow of one or more processes or implementations may be controlled by logic unit 2060 alone or in conjunction with API unit 2065. The input unit 2070 may be configured to obtain input for the calculations described in the example implementations, and the output unit 2075 may be configured to provide output based on the calculations described in example implementations.

Processor(s) 2010 can be configured to receive vibration sensor data from sensors associated with a robotic apparatus configured to perform an activity from a plurality of preset activities as illustrated in FIG. 19; cluster the vibration sensor data to determine the activity the robotic apparatus is performing as illustrated in FIGS. 2 to 4(b) and FIGS. 7 to 8, executing a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window as illustrated in FIGS. 5(a), 5(b), 7, 9, 15, and 16(a) and 16(b); and providing the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus as illustrated in FIGS, 3, 7, 10 and 15.

In an example implementation, the first anomaly calculation process can involve, for the each sample set in the vibration sensor data for the preset time window, obtaining a fluctuation component of the each sample set based on a smoothing of the each sample set according to a moving average of the each sample set; obtaining a threshold based on a corresponding cluster for each sample set determined from the clustering; and generating the first set of the first anomaly scores corresponding to each sample set in the vibration sensor data for the preset time window based on a magnitude of the fluctuation component of the each sample set exceeding the threshold as illustrated in FIG. 9.

In an example implementation, the second anomaly calculation process can involve dividing the first anomaly scores by corresponding clusters determined from the clustering; calculating a batch anomaly score for each of the corresponding clusters based on a magnitude of the first anomaly scores in each of the corresponding clusters exceeding a threshold; and detecting the anomaly or the normal condition of the robotic apparatus based on a summation of the batch anomaly score across each of the corresponding clusters as illustrated in FIG. 10.

In an example implementation, the first anomaly calculation process can include, for each sample set in the vibration sensor data for the preset time window, calculating a spectrum for each sample set based on spectrum analysis; for each of the spectrum, calculating a minimum distance of the each of the spectrum from a learned normal spectrum distribution; and generating the first set of the first anomaly scores corresponding to each sample set in the vibration sensor data for the preset time window based on an average of the minimum distance of the each of the spectrum from the learned normal spectrum pattern as illustrated in FIG. 16(b).

Processor(s) 2010 can also be configured to learn, from normal data, a set of parameters representing normal behavior of the robotic apparatus for each of the plurality of activities as illustrated in FIG. 3.

Processor(s) 2010 can also be configured to aggregate the outputting of the detection of anomaly or normal condition of the robotic apparatus with another output detection of the detection of anomaly or normal condition from a third anomaly calculation process, and generating an alert based on the aggregation as illustrated in FIGS. 19(b) to 19(d).

As described in FIG. 19(a), the activity is can be a type of job configured to be conducted by the robotic apparatus, and the robotic apparatus can be a robotic arm. Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
receiving vibration sensor data from sensors associated with a robotic apparatus configured to perform an activity from a plurality of preset activities;
clustering the vibration sensor data to determine the activity the robotic apparatus is performing;
executing a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window; and
providing the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus.

2. The method of claim 1, wherein the first anomaly calculation process comprises, for the each sample set in the vibration sensor data for the preset time window:
obtaining a fluctuation component of the each sample set based on a smoothing of the each sample set according to a moving average of the each sample set;
obtaining a threshold based on a corresponding cluster for each sample set determined from the clustering; and
generating the first set of the first anomaly scores corresponding to each sample set in the vibration sensor data for the preset time window based on a magnitude of the fluctuation component of the each sample set exceeding the threshold.

3. The method of claim 1, wherein the second anomaly calculation process comprises:
dividing the first anomaly scores by corresponding clusters determined from the clustering;
calculating a batch anomaly score for each of the corresponding clusters based on a magnitude of the first anomaly scores in each of the corresponding clusters exceeding a threshold; and
detecting the anomaly or the normal condition of the robotic apparatus based on a summation of the batch anomaly score across each of the corresponding clusters.

4. The method of claim 1, wherein the first anomaly calculation process comprises, for each sample set in the vibration sensor data for the preset time window:
calculating a spectrum for each sample set based on spectrum analysis;
for each of the spectrum, calculating a minimum distance of the each of the spectrum from a learned normal spectrum distribution; and
generating the first set of the first anomaly scores corresponding to each sample set in the vibration sensor data for the preset time window based on an average of the minimum distance of the each of the spectrum from the learned normal spectrum pattern.

5. The method of claim 1, further comprising learning, from normal data, a set of parameters representing normal behavior of the robotic apparatus for each of the plurality of activities.

6. The method of claim 1, further comprising aggregating the outputting of the detection of anomaly or normal condition of the robotic apparatus with another output detection of the detection of anomaly or normal condition from a third anomaly calculation process, and generating an alert based on the aggregation.

7. The method of claim 1, wherein the activity is a type of job configured to be conducted by the robotic apparatus.

8. The method of claim 1, wherein the robotic apparatus is a robotic arm.

9. A non-transitory computer readable medium, storing instructions for executing a process, the instructions comprising:
receiving vibration sensor data from sensors associated with a robotic apparatus configured to perform an activity from a plurality of preset activities;
clustering the vibration sensor data to determine the activity the robotic apparatus is performing;
executing a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window; and
providing the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus.

10. The non-transitory computer readable medium of claim 9, wherein the first anomaly calculation process comprises, for the each sample set in the vibration sensor data for the preset time window:
obtaining a fluctuation component of the each sample set based on a smoothing of the each sample set according to a moving average of the each sample set;
obtaining a threshold based on a corresponding cluster for each sample set determined from the clustering; and
generating the first set of the first anomaly scores corresponding to each sample set in the vibration sensor data for the preset time window based on a magnitude of the fluctuation component of the each sample set exceeding the threshold.

11. The non-transitory computer readable medium of claim 9, wherein the second anomaly calculation process comprises:
dividing the first anomaly scores by corresponding clusters determined from the clustering;
calculating a batch anomaly score for each of the corresponding clusters based on a magnitude of the first anomaly scores in each of the corresponding clusters exceeding a threshold; and
detecting the anomaly or the normal condition of the robotic apparatus based on a summation of the batch anomaly score across each of the corresponding clusters.

12. The non-transitory computer readable medium of claim 9, wherein the first anomaly calculation process comprises, for each sample set in the vibration sensor data for the preset time window:
calculating a spectrum for each sample set based on spectrum analysis;
for each of the spectrum, calculating a minimum distance of the each of the spectrum from a learned normal spectrum distribution; and
generating the first set of the first anomaly scores corresponding to each sample set in the vibration sensor data for the preset time window based on an average of the minimum distance of the each of the spectrum from the learned normal spectrum pattern.

13. The non-transitory computer readable medium of claim 9, further comprising learning, from normal data, a set of parameters representing normal behavior of the robotic apparatus for each of the plurality of activities.

14. The non-transitory computer readable medium of claim 9, further comprising aggregating the outputting of the detection of anomaly or normal condition of the robotic apparatus with another output detection of the detection of anomaly or normal condition from a third anomaly calculation process, and generating an alert based on the aggregation.

15. The non-transitory computer readable medium of claim 9, wherein the activity is a type of job configured to be conducted by the robotic apparatus.

16. The non-transitory computer readable medium of claim 9, wherein the robotic apparatus is a robotic arm.

17. An apparatus configured to manage a robotic apparatus, the apparatus comprising:
a processor, configured to:
receive vibration sensor data from sensors associated with the robotic apparatus configured to perform an activity from a plurality of preset activities;
cluster the vibration sensor data to determine the activity the robotic apparatus is performing;
execute a first anomaly calculation process on the vibration sensor data, the first anomaly calculation process configured to calculate anomalies from the vibration sensor data for the activity that the robotic apparatus is performing, the output involving a first set of first anomaly scores corresponding to each sample set in the vibration sensor data for a preset time window; and
provide the first set of first anomaly scores to a second anomaly calculation process configured to detect anomalies across a batch of results from the first anomaly calculation process and across the plurality of activities, the second anomaly calculation process outputting a detection of anomaly or normal condition of the robotic apparatus.
